(19) United States
(12) Patent Application Publication
(10) Pub. No.: US 2005/0021468 A1
(43) Pub. Date: Jan. 27, 2005

(54) Methods, systems and computer program products for managing a computer mass storage system that hosts multiple users

(76) Inventor: Marcia L. Stockton, Bakersfield, CA (US)

Correspondence Address: MYERS BIGEL SIBLEY & SAJOVEC, PO BOX 37428, RALEIGH, NC, 27627, US

(21) Appl. No.: 10/623,961

(22) Filed: Jul. 21, 2003

(51) Int. Cl. H04K 1/00

(52) U.S. Cl. 705/51

(57) ABSTRACT

A computer mass storage system that hosts multiple users is managed by obtaining agreement with a user to provide a level of erasure of hosted data from the computer's mass storage system. The hosted data is then erased according to the level of erasure that was agreed upon. One of multiple levels of security also may be agreed upon and provided.

### FIELD OF THE INVENTION

This invention relates to data processing methods, systems and/or computer program products, and more particularly to methods, systems and/or computer program products for managing a data processing system.

### BACKGROUND OF THE INVENTION

Data processing systems, methods and computer program products are widely used in many commercial and personal applications. Often, a data processing system is used by a plurality of users. For example, it is well known to allow a data processing system to provide a plurality of virtual machines that may be used by multiple users.

An extension of multi-user use of a data processing system is “on demand” computing. In on demand computing, a computing resource supplier provides computing resources to a customer when and/or where the customer needs them. Thus, customers need not purchase computing resources based on their highest demand but, rather, can use on demand computing to align their information technology resources with fluctuating demand. On demand computing is described, for example, in a publication entitled The On Demand Era Is Upon Us. Are You Ready?, Copyright IBM 2002, and as also described at the Web page ibm.com/ondemand. Other suppliers are also offering on demand solutions. On demand computing may use autonomic computing systems that can provide self-managed computing systems with reduced or minimal human interference. See, for example, Autonomic Computing: IBM's Perspective on the State of Information Technology, copyright IBM, 2001.

It is well known that a multi-user computing environment may create data security issues. An on demand computing environment may exacerbate these data issues as computer systems and mass storage systems may be repurposed frequently as they host data and/or applications of different users.

### SUMMARY OF THE INVENTION

Some embodiments of the present invention manage a computer mass storage system that hosts a plurality of users, by obtaining agreement with a user to provide a level of erasure of hosted data from the computer mass storage system. The hosted data is then erased according to the level of erasure that was agreed upon. In some embodiments, the hosted data is erased according to the level of erasure that was agreed upon, in response to repurposing of the storage medium on which the hosted data was contained.

In some embodiments of the invention, the level of erasure may include overwriting the hosted data with new data as the new data is generated by another user, bulk erasing the host data and/or destroying at least a portion of the computer mass storage system that included the hosted data. In still other embodiments, single pass bulk erasing or multiple pass bulk erasing of the hosted data may be performed.

Other embodiments of the present invention manage a computer system that hosts a plurality of users by obtaining agreement with a user to provide one of a plurality of levels of security when the computer system hosts the user, and providing the level of security that was agreed upon when the computer system hosts the user. In some embodiments, the levels of security can comprise a plurality of levels of erasure of the computer mass storage system that hosts user data as was described above.

Still other embodiments of the present invention can automatically destroy a business or personal computer mass storage system upon occurrence of a predetermined business or personal event, absent an override within a predetermined time of the predetermined business or personal event. In some embodiments, the predetermined business or personal event can be a changed environmental condition and/or a command from an authorized sender. In some embodiments, the business or personal event is a changed environmental condition and the override comprises a command to ignore the changed environmental condition. In other embodiments, the business or personal event is a first command from an authorized or unauthorized sender and the override comprises a second command from an authorized sender to ignore the first command. In still other embodiments, the predetermined business or personal event is a command that is responsive to bankruptcy of a user of the business or personal computer mass storage system. In yet other embodiments, the predetermined business or personal event is theft of the business or personal computer mass storage system.

### BRIEF DESCRIPTION OF THE DRAWINGS

FIG. 1 is a block diagram of systems, methods and/or computer program products for managing a computer mass storage system that hosts multiple users according to some embodiments of the present invention.

FIGS. 2 and 3 are flowcharts of operations that may be performed to manage computer mass storage according to some embodiments of the present invention.

FIG. 4 is a flowchart of operations that may be performed to manage business or personal computer mass storage according to some embodiments of the present invention.

FIG. 5 is a block diagram of systems, methods and/or computer program products that can be used to manage business or personal computer mass storage according to some embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

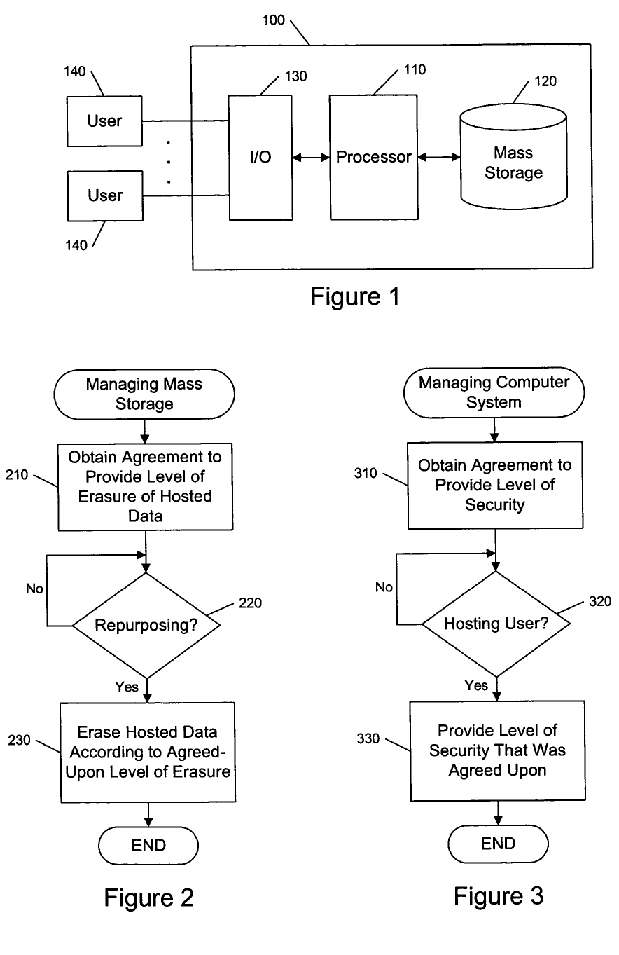

FIG. 1 is a block diagram of systems, methods and/or computer program products according to some embodiments of the present invention. As shown in FIG. 1, a data processing system 100 includes a processor 110, a mass storage system 120 and an input/output (I/O) system 130. The data processing system 100 may include one or more enterprise, personal, pervasive and/or embedded computer systems that may be interconnected by a network such as a local or wide area network including the Internet. As such, the processor 110 may represent one or more enterprise, personal, pervasive and/or embedded processing systems. The input/output system 130 may also represent one or more enterprise, personal, pervasive and/or embedded input/output systems that may allow a plurality of users 140 to access the processor 110. Finally, the mass storage system 120 also may represent one or more enterprise, personal, pervasive and/or embedded mass storage systems. It will be understood that the mass storage system 120 is representative of the overall hierarchy of mass storage memory devices containing the data, including software, used to implement the functionality of the data processing system 100. The mass storage system may include, but is not limited to, the following types of devices: magnetic storage, magneto-optical storage, optical storage and semiconductor storage devices such as flash memory devices.

In some embodiments of the invention, the data processing system 100 is a multi-user computer system. Moreover, in other embodiments of the present invention, the data processing system 100 is an on demand computer system that provides on demand computing for multiple users.

FIG. 2 is a flowchart of operations that may be performed to manage mass storage, such as mass storage system 120 of FIG. 1, according to some embodiments of the present invention. These operations may be performed by the processor 110, I/O system 130 and/or users 140 of FIG. 1.

Referring now to FIG. 2, at Block 210, an agreement is obtained with a user, such as a user 140, to provide a level of erasure of hosted data on the computer mass storage system, such as the mass storage system 120. At Block 220, in some embodiments of the invention, a determination is made as to whether at least a portion of the computer mass storage system 120 that contains the user's hosted data is being repurposed. It will be understood by those having skill in the art that repurposing is used herein to connote that at least a portion of the storage medium of the mass storage system 120 that was used to host data of a user is released for use by a second user. If yes, then at Block 230, the hosted data is erased according to the level of erasure that was agreed upon. It will be understood that in other embodiments, the operations of Block 230 may be performed upon occurrence of a predetermined condition other than repurposing, such as passage of a predetermined time in which the hosted data is not accessed. Yet other events and/or conditions may also trigger the erasing of Block 230.

In some embodiments of the present invention, the agreed upon level of erasure can comprise one or more of the following: overwriting the hosted data with new data as the new data is generated by another user, bulk erasing the hosted data, and/or destroying a portion of the computer mass storage system that includes the hosted data. More specifically, the level of erasure may comprise overwriting the hosted data with new data as the new data is generated by another user. This may correspond to a standard level of service that is offered by conventional legacy, Unix-or Windows-based computer systems, wherein mass storage space is overwritten over time once it is freed up. Alternatively, the level of erasure can comprise bulk erasing the hosted data. Thus, additional action may be taken in order to bulk erase the hosted data rather than waiting for the data to be overwritten by another user or application. This higher level of erasure may be provided for a user upon payment of a higher fee for the higher quality of service.

Finally, the level of erasure may constitute the destruction of at least a portion of the computer mass storage system that includes the hosted data. In these embodiments, destruction may be regarded as a highest level of erasure, wherein the actual media is physically destroyed, for example by destruction of a disk and/or a disk drive including a disk. Destruction may be provided for highly sensitive user data, upon payment of an even higher fee. Accordingly, various levels of erasure may be provided upon agreement with a user and payment of appropriate charges.

Moreover, in some embodiments, sublevels of erasure may be provided within the above-described levels. For example, bulk erasing may be provided by single pass bulk erasing the hosted data for a first fee and/or multiple pass bulk erasing the hosted data for a second fee that is higher than the first fee. The repeated (multiple pass) bulk erasing may use different bulk erasing patterns, to provide a higher assurance that the data is not recoverable.

Additional discussion of embodiments of the invention that may be used in an on demand computer environment now will be provided. In particular, on demand computing may utilize a large number of computers in a grid computing, server farm and/or other distributed environment, to allow processor and/or storage-intensive applications in an on demand environment. Examples may include computational chemistry, analysis of seismic data for petroleum exploration, statistical applications or other processor and/or data-intensive applications for which on demand computing may be used.

In these environments, processors and/or mass storage may be frequently repurposed. A processor may be repurposed while providing a level of security, by loading a new boot image of the processor upon repurposing. The new boot image may make it unnecessary to reinstall the operating system and/or application. However, mass storage conventionally is not overwritten until new data is loaded thereon. Accordingly, a prior user's data may continue to exist in a mass storage system long after the mass storage system has been repurposed.

Embodiments of the present invention can allow a provider of computing resources to specify a level of erasure that may be available to a user upon payment of appropriate fees. A relatively low level of erasure can merely overwrite the hosted data with new data as the new data is generated by another user. A higher level of erasure (and fees) can provide bulk erasing as was described above. A still higher level of erasure (and fees) may actually destroy at least a portion of the computer mass storage system that included the hosted data. Accordingly, users can specify a level of erasure depending upon the sensitivity of their hosted data.

Techniques for providing overwriting, bulk erasing and destruction are well known to those having skill in the art and need not be described in detail herein. For example, in a rotating magnetic storage medium such as a hard drive, in addition to the existing read/write head that typically writes one track at a time, the drive can be equipped with a wide write head or an array of write heads capable of writing all tracks simultaneously. For a rotating optical medium such as CD-read/write, in addition to the single laser beam that is swept across portions of the spiral write path, the drive can be equipped with multiple laser beams or a beam dispersal system, such as a mirror, such that all the surface may be erased in one or two rotations of the medium.

In other embodiments, microcode or firmware can be used to drive existing mass storage hardware so that the application software may issue only one I/O command to the mass storage subsystem to initiate erasure. In still other embodiments, medium and/or drive destruction can take place using excessive voltage, a special set of write heads, a programmed action by the standard write heads, immersion in a chemical bath, excessive heating, a laser beam and/or other techniques that are well known to those having skill in the art for destroying the medium and/or the data storage device itself. In some embodiments, the destruction may take place in the absence of external power.

Embodiments of the present invention have been described above in connection with managing a mass storage system of a computer system such as mass storage system 120 of computer system 100 of FIG. 1. In other embodiments of the present invention, other elements of a computer system in addition to mass storage erasure may be managed.

In particular, as shown in FIG. 3 at Block 310, an agreement is obtained with a user to provide one of a plurality of levels of security when the computer system hosts the user. The level of security may include physical isolation of the computer system, screening of computer operators, mass storage erasure management, user authentication levels and/or other measures that are well known to those having skill in the art.

Referring now to Block 320, when the computer system hosts the user, then at Block 330, the level of security that was agreed upon is provided. Accordingly, a provider of a computing environment may provide a predetermined level of security upon agreement by a user and payment of appropriate charges.

Other embodiments of the present invention can manage a business or personal computer (i.e, a non-military computer) mass storage system, such as the mass storage system 120 of FIG. 1, by automatically destroying the business or personal computer mass storage system upon occurrence of a predetermined business or personal event, absent an override within a predetermined time of the predetermined business or personal event. Specifically, as shown in FIG. 4, a determination is made at Block 410 as to whether the predetermined business or personal event has occurred. If yes, at Block 420, a determination is made as to whether an override has occurred within a predetermined time. If not, then at Block 430, the business computer mass storage system is automatically destroyed.

Accordingly, embodiments of FIG. 4 can provide for the destruction of business-critical or personal data, to prevent exposure of the data in the event that conventional logical and physical barriers protecting the data are breached and/or a business or personal decision is made to destroy the data. The data destruction can destroy the media upon which the data is written, or the entire storage unit including the media and the data.

In particular, mass storage devices may hold vast amounts (terabytes) of critical enterprise data. During a time of war, terrorism or natural disaster, the data in the storage device can fall into the wrong hands, despite physical security measures such as barriers and locked data centers, and logical security measures such as network firewalls, since, during a catastrophe, such measures may be breached. There may be cases where an enterprise would prefer total destruction of its data to exposure of the data. The same may be true when a business fails and its assets are about to be seized by creditors. The same may be true as to personal data in a personal, pervasive or embedded computer system.

Accordingly, some embodiments of the present invention provide automatic destruction of business or personal computer mass storage systems that can be triggered automatically under certain events. The events may include a changed environmental condition and/or a command from an authorized sender or unauthorized sender. The changed environmental condition can include temperature, pressure, shock waves, light, vibration, sound, etc.

It is known to provide self-destruct capabilities for military and intelligence equipment. However, embodiments of the present invention can provide self-destruct or data-destruct capability to business and/or personal computers including one or more enterprise, application, personal, pervasive or embedded computers. It will be understood that the mass storage device can be a large scale (e.g., terabyte or more) mass storage device, but can also apply to smaller scale data (for example gigabyte-sized) storage devices controlled by an individual.

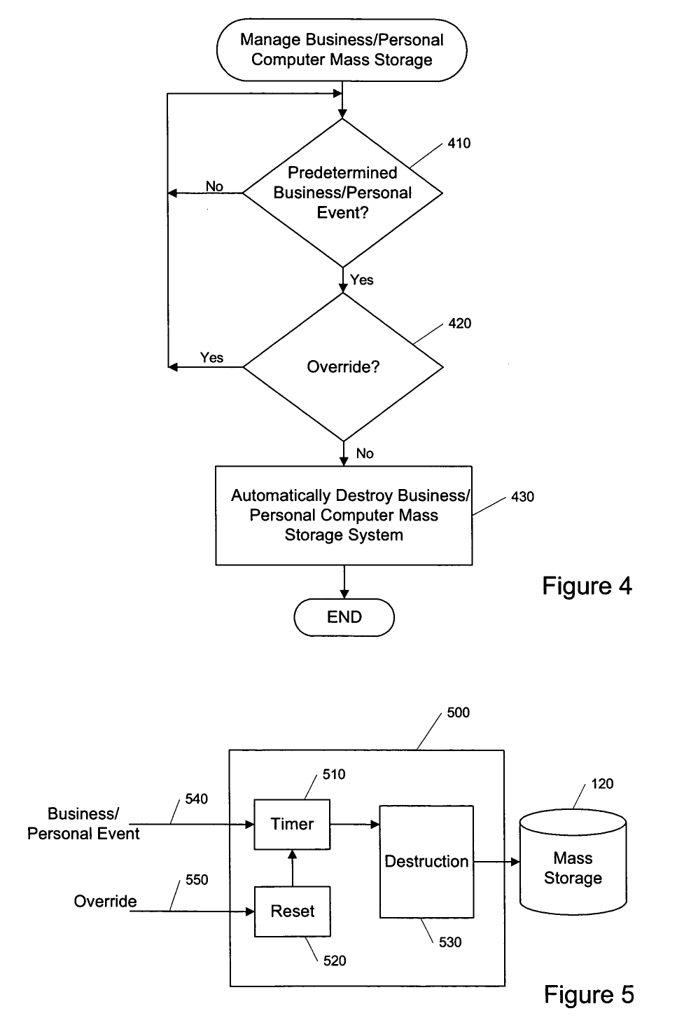

FIG. 5 is a block diagram of some embodiments of the present invention that can be used to manage business/personal computer mass storage according to the operations of FIG. 4. In some embodiments, the business/personal computer mass storage management system 500 may be embodied in a mass storage unit 120 and/or processor 110 of FIG. 1 and/or may be separate therefrom.

Referring now to FIG. 5, a timer 510 may be a single shot countdown hardware timer and/or software timer that is capable of operating for a period of time exceeding a timeout value, even if external power is interrupted. The timer may be initiated upon occurrence of a business/personal event 540.

As was described above, the business/personal event may be a changed environmental condition and/or a command from an authorized or unauthorized sender. A command from an unauthorized sender may occur upon theft and/or hacking. A command from an authorized sender may occur upon bankruptcy of the user. The reset circuit 520 can be responsive to an override command 550 that may issued over an I/O channel by an authorized entity and/or a secret code that is input directly into I/O inputs of the storage device, for example using a keypad, by an authorized person. The override may comprise a command to ignore the changed environmental condition or to ignore the initial command from the authorized or unauthorized sender.

When the reset circuit 520 receives the override command 550, the timer 510 is reset to its maximum value. If the timer 510 counts down to zero or another predetermined number before the override is received, the destruction module 530, also referred to as a data destruction module, is triggered automatically. The data destruction module 530 can use excessive voltage, a special set of write heads, a programmed action by the normal write heads, immersion in a chemical bath, excessive heating, a laser beam, etc., that may be activated quickly but not accidently, and rapidly destroy the mass storage system.

Accordingly, a service provider can provide differential levels of data security for the erasure of hosted data. For a premium level of security, the service provider can overwrite or bulk erase the data storage media more thoroughly before repurposing the machine/media for another customer's data. This can be done using policies to specify the level of service, and an implementation that is capable of performing the more thorough erasure.

In the drawings and specification, there have been disclosed embodiments of the invention and, although specific terms are employed, they are used in a generic and descriptive sense only and not for purposes of limitation, the scope of the invention being set forth in the following claims.

1. A method of managing a computer mass storage system that hosts a plurality of users comprising:
obtaining agreement with a user to provide a level of erasure of hosted data on the computer mass storage system; and
erasing the hosted data according to the level of erasure that was agreed upon.

2. A method according to claim 1 wherein the level of erasure comprises:
overwriting the hosted data with new data as the new data is generated by another user;
bulk erasing the hosted data; and/or
destroying at least a portion of the computer mass storage system that includes the hosted data.

3. A method according to claim 2 wherein bulk erasing comprises:
single pass bulk erasing the hosted data; or
multiple pass bulk erasing the hosted data.

4. A method according to claim 3 wherein multiple pass bulk erasing comprises:
repeatedly bulk erasing the hosted data, with different bulk erasing patterns.

5. A method according to claim 1 wherein the hosted data is contained in a storage medium of the computer mass storage system and wherein the erasing comprises erasing the hosted data according to the level of erasure that was agreed upon, in response to repurposing the storage medium.

6. A method of managing a computer system that hosts a plurality of users comprising:
obtaining agreement with a user to provide one of a plurality of levels of security when the computer system hosts the user; and
providing the level of security that was agreed upon when the computer system hosts the user.

7. A method according to claim 6 wherein the computer system comprises a computer mass storage system and wherein the plurality of levels of security comprises a plurality of levels of erasure of a computer mass storage system that hosts user data.

8. A method of managing a business or personal computer mass storage system comprising:
automatically destroying the business or personal computer mass storage system upon occurrence of a predetermined business or personal event, absent an override within a predetermined time of the predetermined business or personal event.

9. A method according to claim 8 wherein the predetermined business or personal event comprises:
a changed environmental condition; and/or
a command from an authorized sender.

10. A method according to claim 8 wherein the predetermined business or personal event is a changed environmental condition and wherein the override comprises a command to ignore the changed environmental condition.

11. A method according to claim 8 wherein the business or personal event is a first command from an authorized or unauthorized sender and wherein the override comprises a second command from an authorized sender to ignore the first command.

12. A method according to claim 8 wherein the predetermined business or personal event is a command that is issued responsive to bankruptcy of a user of the business or personal computer mass storage system.

13. A method according to claim 8 wherein the predetermined business or personal event is theft of the business or personal computer mass storage system.

14. A system for managing a computer mass storage system that hosts a plurality of users comprising:
means for obtaining agreement with a user to provide a level of erasure of hosted data on the computer mass storage system; and
means for erasing the hosted data according to the level of erasure that was agreed upon.

15. A system according to claim 14 wherein the level of erasure comprises:
overwriting the hosted data with new data as the new data is generated by another user;
bulk erasing the hosted data; and/or
destroying at least a portion of the computer mass storage system that includes the hosted data.

16. A system according to claim 14 wherein the hosted data is contained in a storage medium of the computer mass storage system and wherein the means for erasing comprises means for erasing the hosted data according to the level of erasure that was agreed upon, in response to repurposing the storage medium.

17. A system for managing a computer system that hosts a plurality of users comprising:
means for obtaining agreement with a user to provide one of a plurality of levels of security when the computer system hosts the user; and
means for providing the level of security that was agreed upon when the computer system hosts the user.

18. A business or personal computer system comprising:
a business or personal computer mass storage system; and
means for automatically destroying the business or personal computer mass storage system upon occurrence of a predetermined business or personal event, absent an override within a predetermined time of the predetermined business or personal event.

19. A system according to claim 18 wherein the predetermined business or personal event comprises:
a changed environmental condition; and/or
a command from an authorized sender.

20. A system according to claim 18 wherein the means for automatically destroying comprises:
a timer that is responsive to the business/personal event;
a reset module that is responsive to the override to reset the timer; and
a destruction module that is responsive to the timer to destroy at least a portion of the mass storage system.
